(19) United States
(12) Patent Application Publication
(10) Pub. No.: US 2017/0057191 A1
(43) Pub. Date: Mar. 2, 2017

(54) FOLDING STATION AND FOLDING-BOX ADHESIVE-BONDING MACHINE

(71) Applicant: KAMA GmbH, Dresden (DE)

(72) Inventor: Bernd HERFURTH, Dresden (DE)

(73) Assignee: KAMA GmbH, Dresden (DE)

(21) Appl. No.: 15/309,217

(22) PCT Filed: Apr. 15, 2015
(86) PCT No.: PCT/EP2015/058132

§ 371 Date: Nov. 7, 2016

(30) Foreign Application Priority Data
May 19, 2014 (DE) 10 2014 107 031.3

(51) Int. Cl. B31B 1/26

(52) U.S. Cl. CPC B31B 1/26; B31B 2201/26; B31B 2203/003

(57) ABSTRACT

Folding station and folding-box adhesive-bonding machine are provided. The folding station for deforming flat workpieces includes at least one group of k guide mechanisms, which are fitted at a variable distance from one another along an arrangement line. The guide mechanisms are operatively connected to a common, proportionally active adjustment device which, during operation, varies the distances between in each case two adjacent guide mechanisms of the group of guide mechanisms uniformly along the arrangement line. Also provided is a folding-box adhesive-bonding machine having a transporting device for folding-box blanks and having at least one such folding station.

The invention relates to a folding station for forming flat workpieces, in particular in the manufacture of folding boxes from cardboard blanks, and to a folding-box adhesive-bonding machine having a folding station of this type.

In folding-box adhesive-bonding machines, folding-box blanks are conveyed at a predefinable conveying speed along a conveying path, wherein the folding-box blank is a flat projection of the folding box to be manufactured that has a central part and lateral parts that are disposed laterally of said central part. In order for the folding box to be manufactured, the lateral parts along folding grooves that run between the central part and the lateral part, are sequentially inwardly pivoted over a folding line toward the longitudinal center of the blank, and are finally placed together and adhesively bonded to one another.

A folding-box machine which serves for forming folding-box blanks into tubular folding boxes is known from DE 102 41 448. The folding-box blanks correspond to the flat projection of a folding box to be manufactured. Folding has to be carried out with significant precision, as the equal angle of the completed folding box is decisively determined by said folding.

In order for the tubular folding box to be produced, so-called folding belts or folding tapes are used which bear on those parts to be folded back, the lateral parts of the folding-box blank, and force folding longitudinally along the folding line. The folding belts by way of the operating leader run longitudinally along a type of helical line, wherein the folding belt acts on those parts to be folded inward. In order for the folding movement to progress in an orderly manner, the folding belts run at a web speed which corresponds to the web speed of the blank. In order for the equal angle of the completed folding box to the guaranteed, a multiplicity of loose rotatable disks which contact the folding-box blank in the vicinity of the folding lines are disposed in the folding line.

A further folding station for folding blanks is known from DE 44 39 198 A1. Folding is performed in a manner known per se by so-called folding belts which grip the lateral flaps from below. The folding belts herein run from a plane below to a plane above the central part. The axes of the folding belts herein are mutually crossed in such a manner that the folding-tape face that faces the blank is turned by a total of 180° along the conveying path of the blank. In order for the predefined tight tolerances to be maintained when the blanks are being folded, an edge-bending device is disposed in the front region of the conveying path in the region of the fold lines of the blanks.

A folding station in which the spacing of the folding belt from the folding line of the blank is embodied so as to be adjustable such that the folding belt constantly acts on an external region of the lateral part is described in EP 1 604 812 A1. On account thereof, it is enabled that dissimilar blanks are acquired at that region of the lateral parts that is most favorable for folding. By contrast, the readjustment of the guide rollers guiding the folding belt is only possible by separately loosening, traversing, and fastening each individual guide roller. These operations are tedious and therefore lead to long downtimes when the machine has to be adjusted to a smaller or to a larger folding-box blank.

One object of the invention therefore lies in stating a folding station which enables fast, simple, and precise adjustment of the guide elements such that the folding station is adaptable in a simple and rapid manner to another, for example a larger or a smaller, folding-box blank.

To this end, it is proposed in the case of a folding station for forming flat workpieces, comprising at least one group of guide elements which along a layout line are attached having a variable mutual spacing w, that the guide elements are operatively connected to a common and proportionally acting adjustment installation which during operation uniformly varies the spacings between each two adjacent guide elements of the group of guide elements along the layout line.

In other words, when viewed from a fixed point of the transportation path, by activating a common adjustment installation, k guide elements are traversed by k times a predefinable adjustment path. This means that the adjustment installation moves the first guide element (k=1) by an amount s of the path along the layout line, wherein the second guide element (k=2) simultaneously is moved by the amount 2s, the third guide element (k=3) is moved by the amount 3s, etc. The adjustment paths of the individual guide elements are thus proportional to their numerical index, i.e. this is a proportionally acting adjustment installation, leading to the spacing of each two adjacent guide elements being uniformly varied and the amounts by which the mutual spacing of each two adjacent guide elements is varied being constantly of identical size when the adjustment installation is activated.

Herein, guide elements are to be understood as means that are suitable to act on a tab of a folding-box portion such that this tab when transported along the transportation path of a folding-box adhesive-bonding machine, that is to say parallel with the layout line of the guide elements, is folded in relation to the remainder of the folding-box blank.

Guide elements of this type may be for example rollers, brackets, or plough-type folding rails which at an angle that in relation to the transportation direction of the folding-box blanks is variable in steps act directly on the folding-box blank, or may be suchlike elements which support a folding belt that is twisted along the transportation path, wherein in this case the folding belt is that element that acts directly on the folding-box blank.

The fundamental concept of the invention lies in providing the folding station with an adjustment installation which proportionally acts simultaneously on a plurality of guide elements, independently of how the adjustment installation is specifically designed. Each adjustment installation which acts simultaneously on a plurality of guide elements and herein uniformly varies the relative mutual spacings between the guide elements k and k+1 (w_{k/k+1}) such that the increase or decrease of the mutual spacings is identical at any point in time (Δw_{k/k+1}=const.) is considered to be an adjustment installation in the context of the disclosed teaching.

In the simplest case herein, each guide element is operatively connected to a dedicated drive installation, for example to a servo motor, and all drive installations are actuated such that the guide elements are proportionally moved as has been described. While such a design embodiment is relatively complex, it is to be considered as being within the inventive concept.

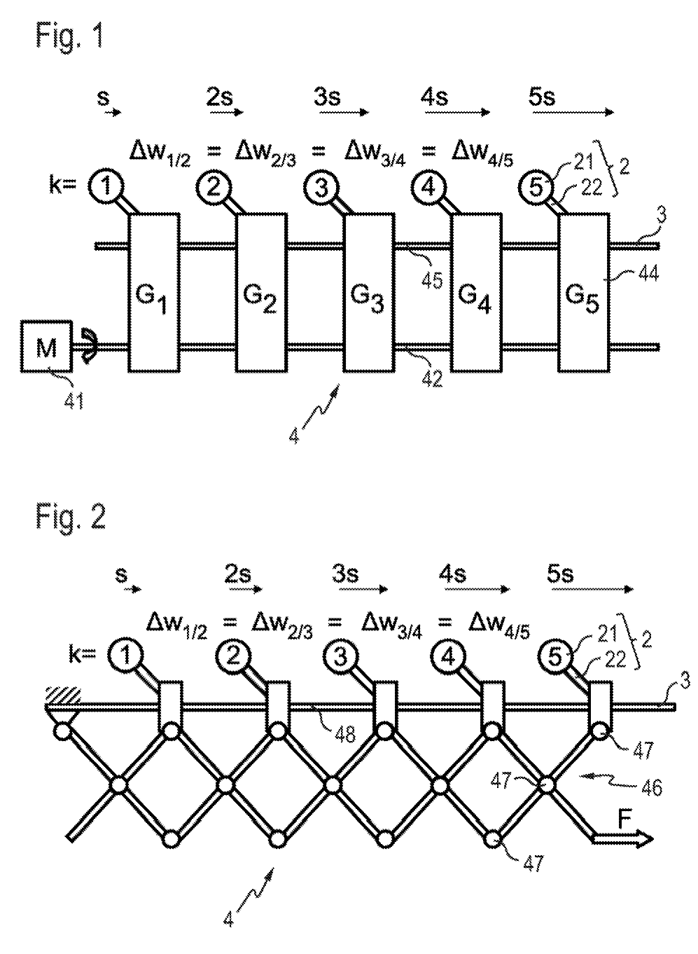

For example, adjustment installations as are schematically illustrated in FIG. 1 and in which the adjustment installation for each guide element has one gearbox that acts on this guide element, wherein each of these gearboxes has another gearing, are also included.

For example, a shaft to which further elements of the adjustment installation, such as gear wheels, belt pulleys, screw collars, or the like, are attachable in a locationally fixed or an axially traversable manner, may be used as a drive spindle. Moreover, the further elements of the adjustment installation, depending on the function of the former, may be attached according to requirements in a rotationally fixed manner to the drive spindle, for example by way of a form fit, wherein known means such as interaction of grooves and correspondingly shaped cams or splined keys (cf. DIN 6885, ASME B 17.1), or splined shafts (cf. ISO 14, SAE J449, ANSI B92.1, B92.2) having correspondingly shaped splined-hub profiles on the further elements are advantageously usable.

Furthermore, for example, adjustment installations in which each guide element has a spindle nut sitting on a drive spindle that is embodied as a threaded spindle, wherein the drive spindle has various portions having threads of dissimilar thread pitch, and the spindle nut has a thread corresponding to the respective portion of the drive spindle and having the same pitch as the associated thread portion, also are included. The desired effect is also achieved by an adjustment installation of this type by the dissimilar thread pitches adapted for each spindle nut.

Adjustment installations as schematically illustrated in FIG. 2, in which the guide elements are connected to articulation points of a scissor-type mechanism, which articulation points, when the scissor-type mechanism is activated, are uniformly converged or diverged, are likewise to be considered as according to the invention.

In one design embodiment of the invention it is provided that the adjustment installation has at least one spindle drive and at least one screw collar which interacts with the at least one drive spindle and the guide elements.

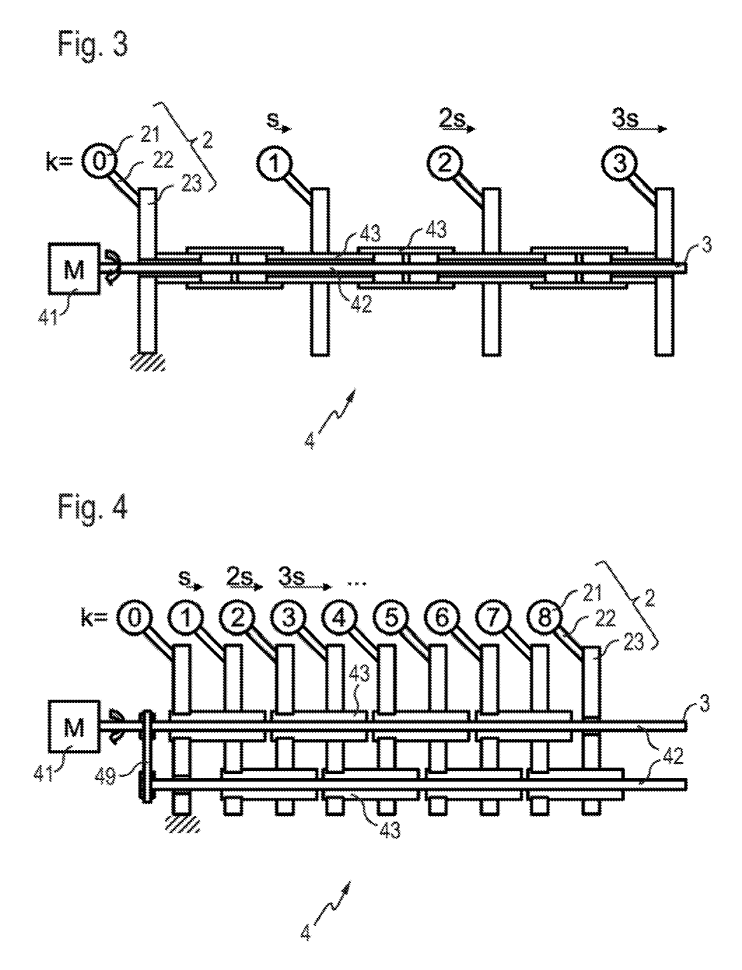

For example, the drive spindle may be routed through the screw collars which are fastened to the guide elements or the mountings of the latter. One screw collar which during operation of the adjustment installation conjointly rotates with the drive spindle may be disposed on the drive spindle between each two guide elements, for example. Should the two screw collars of the adjacent guide elements now have opposing threads, and should the screw collar that is fastened to the drive spindle have two portions with opposing threads, each interacting with one of the two screw collars of the two guide elements, then the relative spacing w of the two guide elements is enlarged or reduced, depending on the rotation direction of the drive spindle. An exemplary embodiment thereof is illustrated in FIG. 3.

It may furthermore be provided that the screw collars are disposed so as to be rotatably fastened to the guide elements and to be rotationally secured and traversable on the drive spindle.

According to one further design embodiment it is provided that two drive spindles are disposed so as to be mutually parallel, wherein a first drive spindle is operatively connected to all guide elements having an odd numerical index k, and a second drive spindle is operatively connected to all guide elements having an even numerical index k.

Herein it may furthermore be provided that each two adjacent guide elements are operatively interconnected by in each case one screw collar. An exemplary embodiment thereof is illustrated in FIG. 4.

In the specification to this point it has always been assumed that each of the guide elements that is operatively connected to the adjustment installation during the operation of the adjustment installation is moved along the layout line. However, such embodiments in which a guide element is immovable, and all other guide elements move in relation to this fixedly disposed guide element are also conjointly comprised by the invention.

Therefore, it is provided in one further design embodiment that a zeroth guide element (k=0) is fixedly disposed, and all other guide elements (k>0) during operation of the adjustment installation are moved toward the zeroth guide element or away from the zeroth guide element.

For example, the beginning or the end of a forming section that extends along the transportation path of the folding-box blanks to be formed may be predefined, that is to say be invariable, on a folding-box adhesive-bonding machine. In this case it is expedient for a guide element to be immovably disposed at this beginning or end of the forming section.

In one further design embodiment it is provided that at least two groups of guide elements are disposed along the same layout line and are operatively connected to the same proportionally acting adjustment installation. On account thereof, it is possible for two or more groups of guide elements to be simultaneously adjusted, on the one hand, on account of which the constructive effort is reduced. On the other hand, configuration variations of various types may be performed by one and the same adjustment installation, for example when two groups of guide elements have to be adjusted, but the variation of the relative spacings of adjacent guide elements from one another in the groups is to be dissimilar.

Herein, it may furthermore be provided that during operation of the adjustment installation the spacing of each two adjacent guide elements of a first group is enlarged, and at the same time the spacing of each two adjacent guide elements of a second group is reduced.

For example, it may be desirable for a specific forming step to be performed first on a specific portion of the transportation path of the folding-box blanks to be formed, and subsequently thereto the folding-box blank is only to be held on the transportation installation and in this way to be moved to the end of the transportation path. The length of that part-portion of the transportation path that is required for the forming step may vary depending on the size of the folding-box blank.

By way of the design embodiment described, in which the spacing of each two adjacent guide elements of a first group may be enlarged, and at the same time the spacing of each two adjacent guide elements of a second group is reduced, it is possible for that part-portion that is required for the forming step and the subsequent part-portion on which the folding-box blank is only held on the transportation installation to be mutually adapted such that the sum of both part-portions remains constant. For example, should the first part-portion be extended in length in that the spacings of those guide elements that participate in forming are enlarged, the second part-portion at the same time is shortened in that the spacings of those guide elements that only hold the folding-box blank on the transportation installation are decreased, on account of which the portion of the transportation path that is formed by the sum of the two part-portions remains the same in terms of length.

The described folding station is highly advantageously usable in folding-box adhesive-bonding machines which are known per se and which have a transportation installation for folding-box blanks. Said folding station may also be retrofitted with relatively minor effort on already existing folding-box adhesive-bonding machines.

The invention will be explained in more detail hereunder by means of exemplary embodiments and associated drawings in which:

FIG. 1 shows a proportional adjustment installation having gearboxes with various gearing;

FIG. 2 shows a proportional adjustment installation having a scissor-type mechanism;

FIG. 3 shows a proportional adjustment installation having first screw collars which are attached in a rotationally fixed manner on the guide elements, and having a plurality of second screw collars which are disposed so as to be axially traversable and rotationally fixed on a drive spindle;

FIG. 4 shows a proportional adjustment installation having screw collars which are rotatably attached to the guide elements and which are alternatingly disposed so as to be axially traversable and rotationally fixed on one of two drive spindles, and interact with a thread of an adjacent guide element;

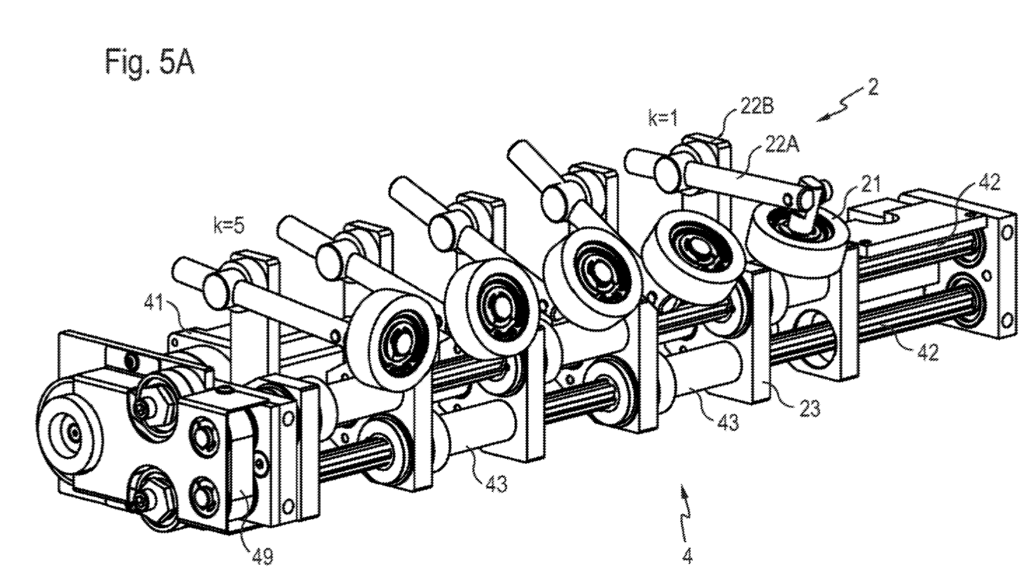

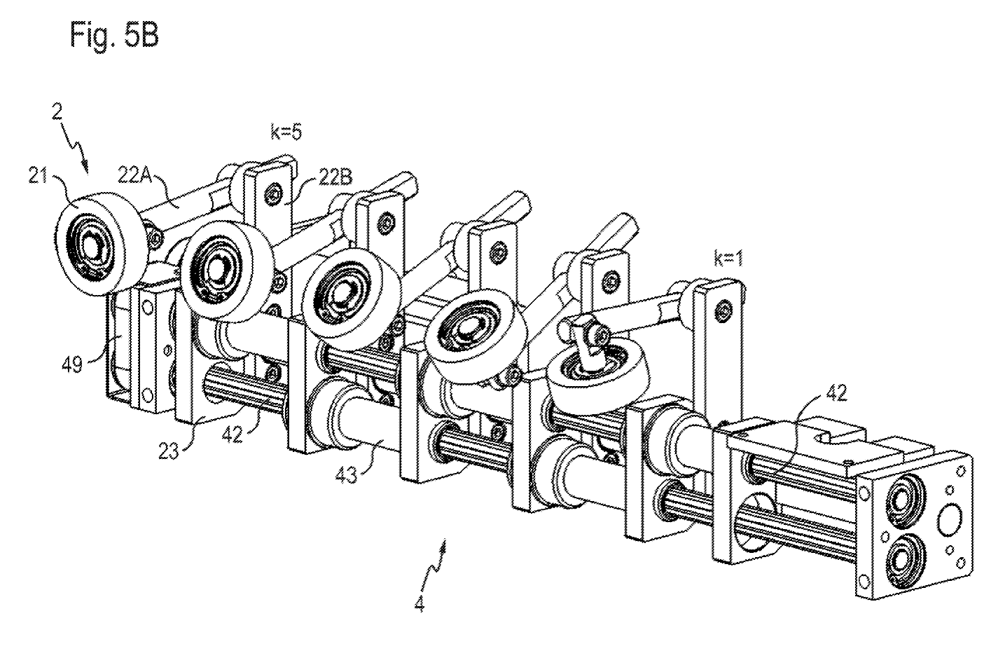

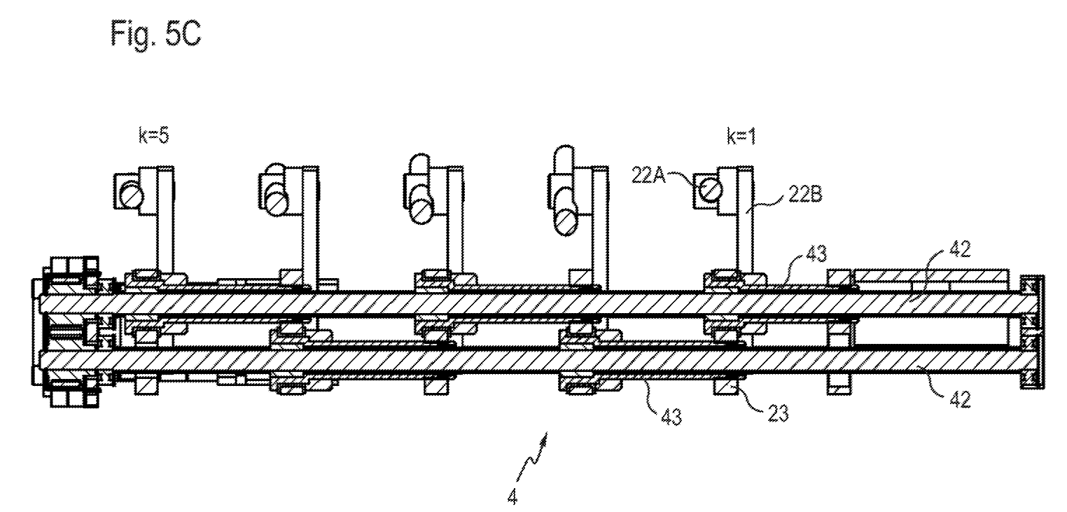

FIGS. 5A, 5B, and 5C show a first exemplary embodiment of the adjustment installation according to FIG. 4, in perspective views and in the longitudinal section;

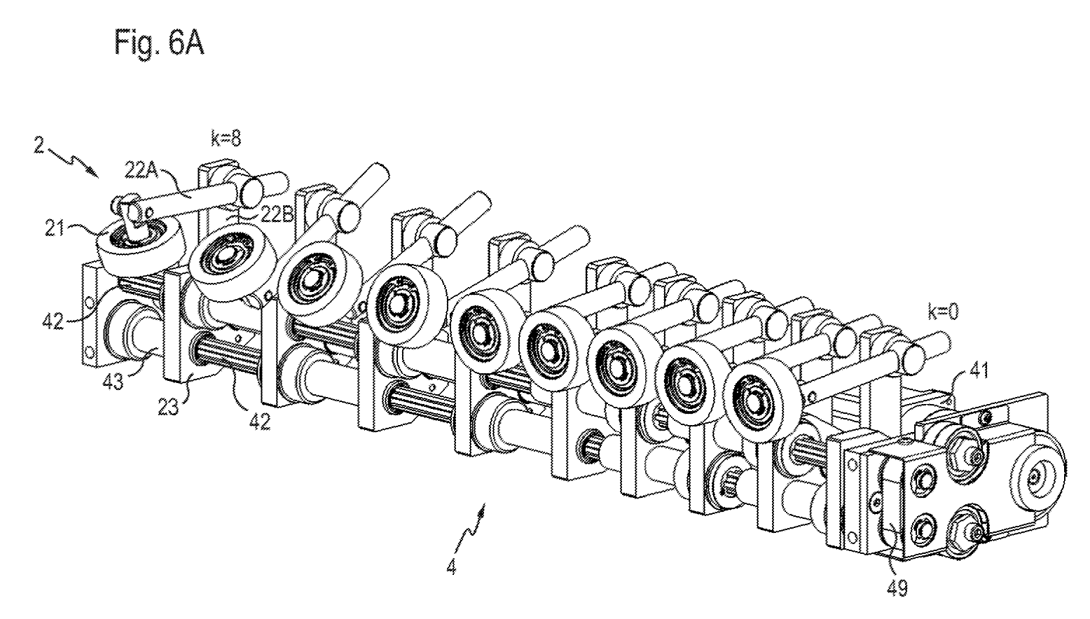

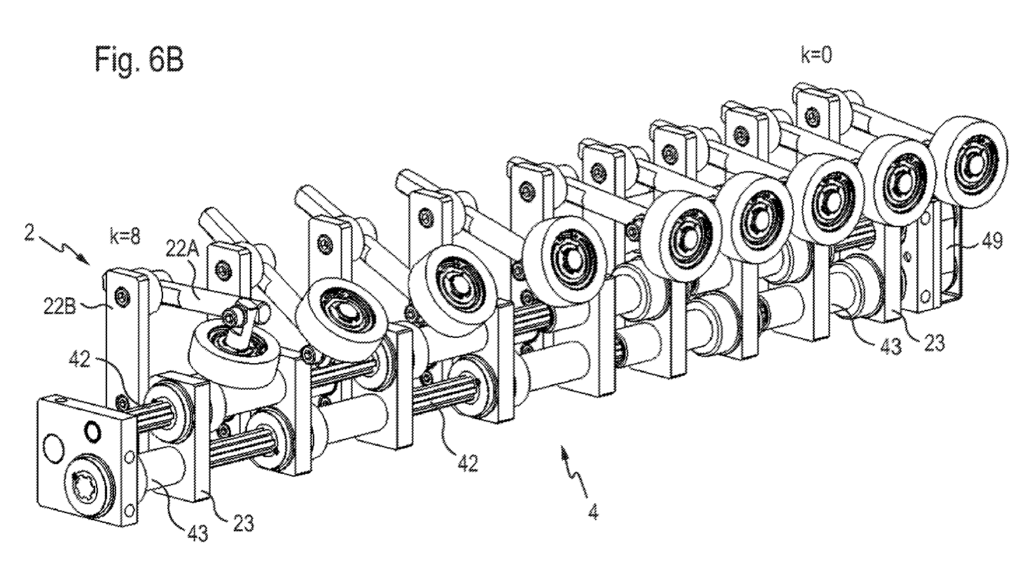

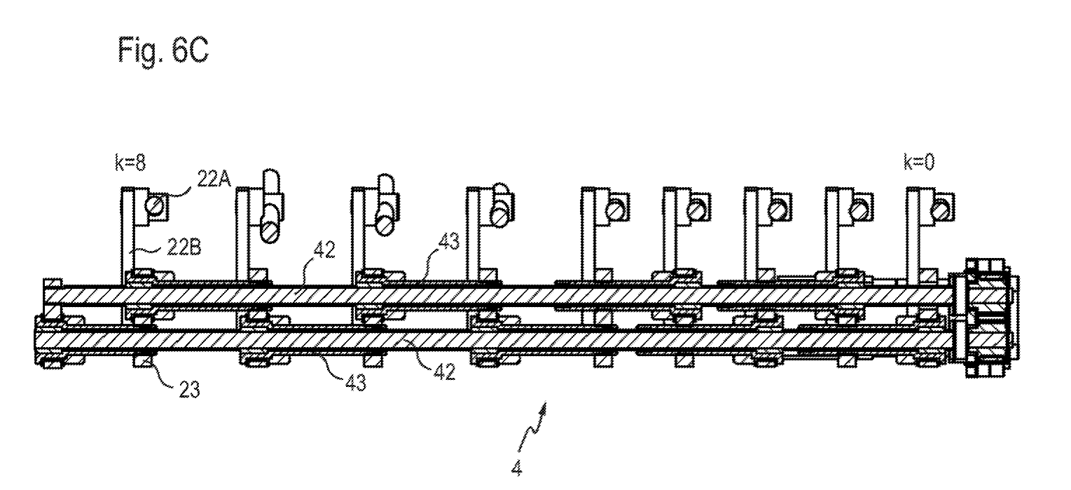

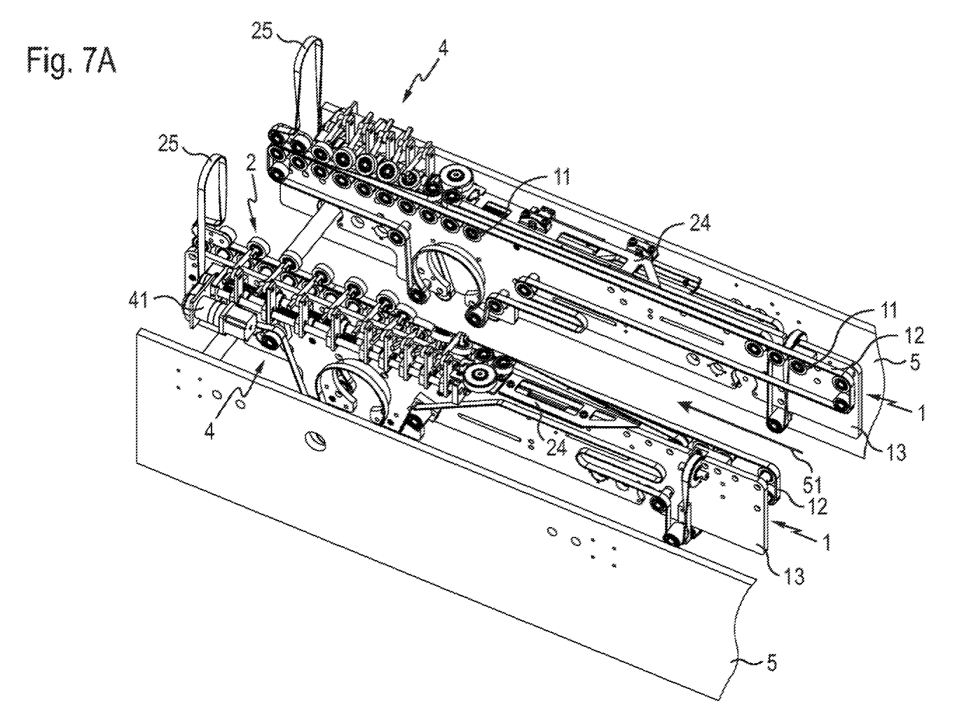

FIGS. 6A, 6B, and 6C show a second exemplary embodiment of the adjustment installation according to FIG. 4, in perspective views and in the longitudinal section; and

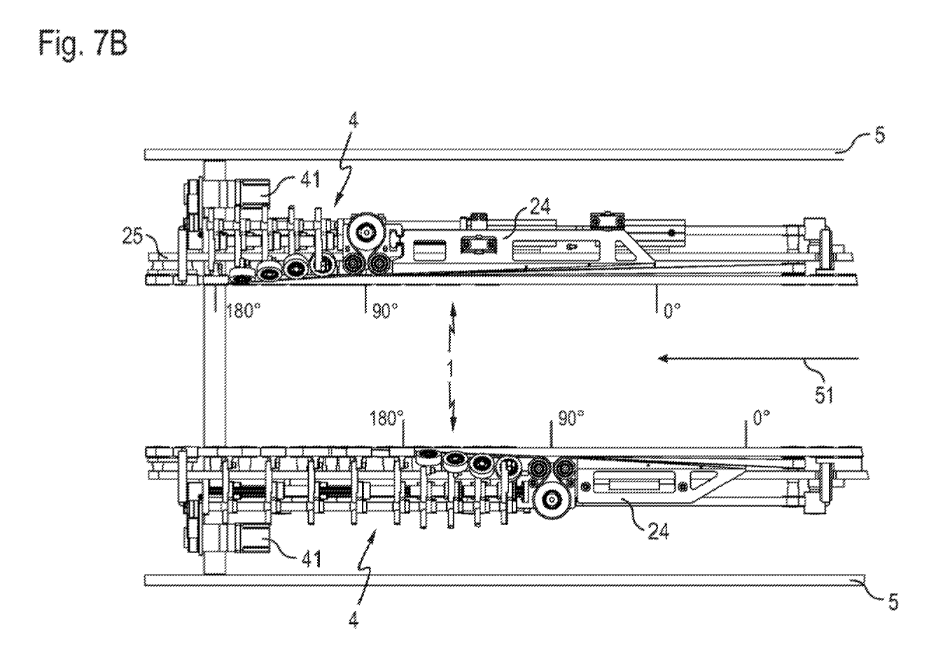

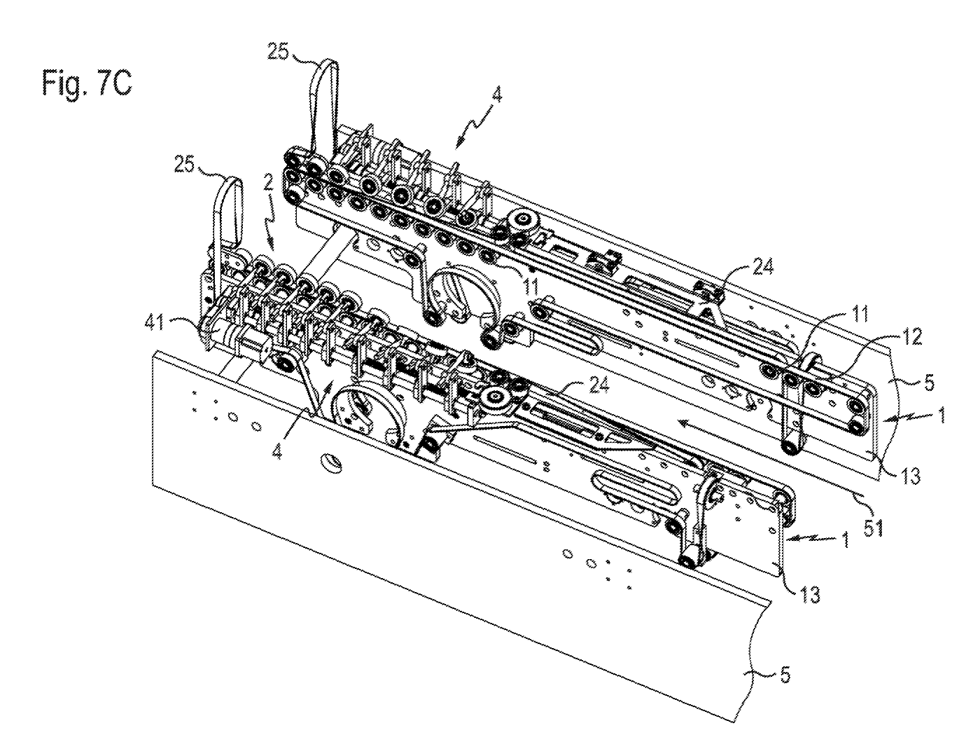

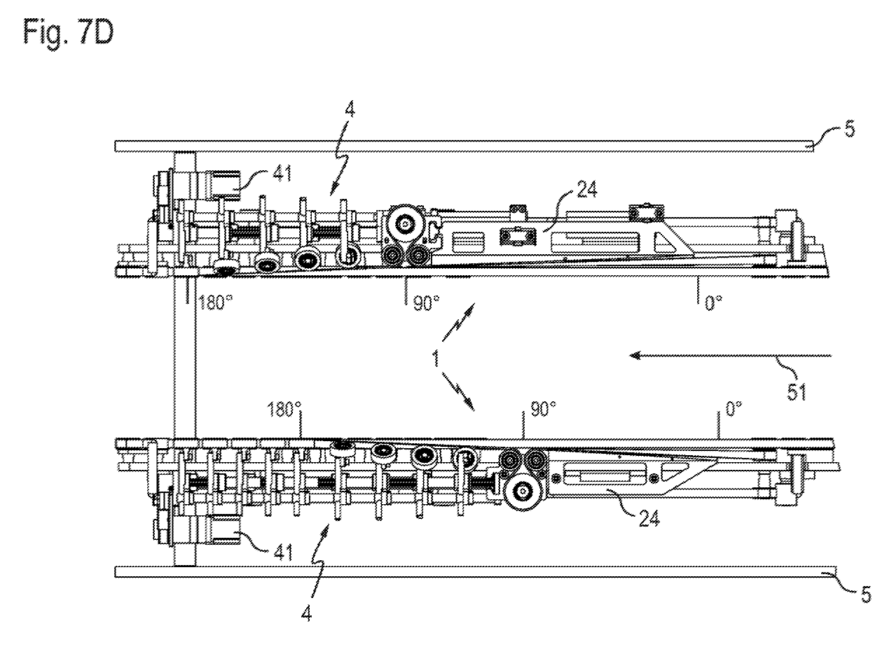

FIGS. 7A, 7B, 7C, and 7D show a part-view of a folding-box adhesive-bonding machine having folding stations according to FIGS. 5A, 5B, and 5C, and 6A, 6B, and 6C, for two dissimilar configurations, each in a perspective view and in a plan view.

An adjustment installation 4 which for each guide element 2 has a gearbox 44 acting thereon is schematically illustrated in FIG. 1, wherein each of these gearboxes 44 has another gearing, and all gearboxes 44 are operatively connected in a direct manner or, for example, by way of one or a plurality of drive spindles 42 or the like, which simultaneously represent the layout line 3 of the guide elements 2, to a common drive installation 41 such as a motor, a manual crank, or the like. The guide elements 2 which presently are illustrated schematically as rollers 2 having roller mounts 22 are traversably disposed on a rack 45 on which the gearbox 44 that is driven by the respective drive spindle 42 acts, and in this way traverses each guide element 2 by an adjustment path of which the length is proportional to the numerical index k of the respective guide element such that the spacing variations Δw are of identical size. The desired effect is achieved by the gearings which are adapted to each gearbox 44.

FIG. 2 shows schematically an adjustment installation 4, in which the guide elements 2 are connected to articulation points 47 of a scissor-type mechanism 46, which articulation points 47 when the scissor-type mechanism 46 is activated, for example by the influence of a force F acting parallel with the layout line 3 of the guide elements 2, are uniformly converged or diverged. The layout line 3 of the guide elements 2 in FIG. 2 is represented by a sliding rail 48 on which the guide elements 2 are traversably disposed. The desired effect of the spacing variations Δw of all pairs of adjacent guide elements 2 being of identical size is achieved by the functioning mode of the scissor-type mechanism 46.

An adjustment installation 4 in which the drive spindle 42 is routed through screw collars 43 which are fastened to the mountings 23 of the guide elements 2 is illustrated schematically in FIG. 3. The guide elements 2 have stationary screw collars 43 which are attached to the mountings 23 and which face the respective adjacent guide element 2. The two mutually protruding screw collars 43 of each two adjacent guide elements 2 have opposing external threads.

One screw collar 43 for each spacing w between two adjacent guide elements 2, which are engaged with the external threads of the screw collars 43 of the guide elements 2 and during operation of the adjustment installation 4 rotate conjointly with the drive spindle 42, is disposed in a rotationally secured and axially traversable manner on the drive spindle 42 which extends through the screw collars 43 of the guide elements 2 and which simultaneously represents the layout line 3 of the guide elements 2. These screw collars 43 each have two portions which, so as to correspond to the external threads of the mutually converging threads of the screw collars 43 of the guide elements 2, have opposing internal threads.

The screw collar 43 that is disposed on the drive spindle 42 interacts with the two screw collars 43 of the two adjacent guide elements 2, on account of which the relative spacing w of the two guide elements 2 is enlarged or decreased depending on the rotation direction of the drive spindle 42. Should the drive spindle 42 be rotated, by way of each of the screw collars 43 that is disposed on the drive spindle 42, the two screw collars 43, engaged therewith, of the adjacent guide elements 2 are tightened or released depending on the rotation direction, such that the spacing w between the adjacent guide elements 2 is reduced or enlarged, respectively.

An adjustment installation 4 in which each two adjacent guide elements 2 are operatively interconnected by in each case one screw collar 43 is schematically illustrated in FIG. 4. The guide elements 2 herein have screw collars 43 which are rotatably disposed on the mounting 23 and which face the respective adjacent guide element 2. These screw collars 43 have an external thread. The screw collars 43 of all guide elements 2 having an odd numerical index k are disposed in a first line, and the screw collars 43 of all guide elements 2 having an even numerical index k are disposed in a second line.

The mountings 23 of the guide elements 2 that are adjacent to guide elements 2 on the mountings 23 of which a screw collar 43 is disposed, have an internal thread into which engages the external thread of the screw collar 43. One drive spindle 42 in each of the first line and the second line extends through the respective screw collars 43 disposed there, which are disposed on said drive spindle 42 in a rotationally secured and axially traversable manner. Both drive spindles 42 are uniformly driven by a common motor 41, wherein one drive spindle 42 is connected directly to the motor 41, and the two drive spindles 42 are operatively interconnected by a belt drive 49. Should the drive spindles 42 be rotated, by way of the screw collars 43 that are disposed on the drive spindles 42, the two adjacent mountings 23, engaged therewith, of the guide elements 2 are tightened or released depending on the rotation direction, such that the spacing w between the adjacent guide elements 2 is reduced or enlarged, respectively.

Specific exemplary embodiments of adjustment installations 4 which each are a component part of a folding station 1 for forming folding-box blanks in a folding-box adhesive-bonding machine, as is illustrated in an exemplary manner in FIGS. 7A, 7B, 7C, and 7D are illustrated in FIGS. 5A, 5B, and 5C, and 6A, 6B, and 6C.

Both adjustment installations according to FIGS. 5A, 5B, and 5C, and according to FIGS. 6A, 6B, and 6C, each serve for further folding a lateral tab of a folding-box blank from a vertical alignment such that said tab is ultimately horizontally aligned and thus in relation to the remainder of the blank is folded by 180°. To this end, the two adjustment installations according to FIGS. 5A, 5B, and 5C, or according to FIGS. 6A, 6B, and 6C, respectively, are expediently attached on each side of the transportation path for to-be-formed folding-box blanks of a folding-box adhesive-bonding machine, as will be explained in more detail hereunder with reference to FIGS. 7A to 7D.

Each guide element 2 comprises a roller 21 which is rotatably fastened to a dual-member roller mount 22. The roller 21 herein in relation to the roller mount 22 is pivotable about a horizontal axis. Moreover, the two members 22A, 22B of the roller mount 22 are interconnected in an articulated manner such that the one member 22A in relation to the other member 22B is pivotable about a horizontal axis. Moreover, the articulated connection between the two members 22A, 22B is variable, that is to say that the free length of the pivotable member 22A is adjustable.

Each dual-member roller mount 22 is fastened to a plate-shaped mounting 23. The mountings 23 of all guide elements 2 are disposed so as to be mutually spaced apart along a layout line 3.
Each mounting 23 has a pair of bores. Two rotatably mounted drive spindles 42 which are embodied as splined shafts extend through each pair of bores of all mountings 23. Both drive spindles 42 by way of a belt drive 49 are connected to a common drive installation 41 in the form of an electric motor such that said drive spindles 42 rotate in a synchronous manner when the electric motor 41 is operated.

The mountings 23, in each case in an alternating manner in one of the two bores of the pair of bores, have a screw collar 43 which is rotatably attached to the respective mounting 23. The screw collars 43 in the interior thereof each have one splined-hub profile which communicates with the external contour of the drive spindles 42 such that the screw collars 43 are rotationally secured on the drive spindles 42 but may slide on the latter in the axial direction of the drive spindles 42. On the free ends thereof, the screw collars 43 are provided with an external thread which engages in a corresponding internal thread in the associated bore of the mounting 23 of the adjacent guide element 2.

Should the drive spindles 42 be rotated, depending on the rotation direction of the drive spindles 42, the external threads of the screw collars 43 are either screwed into the internal threads of the bores of the mountings 23 of the adjacent guide elements 2, or the external threads of the screw collars 43 are screwed out of the internal threads of the bores of the mountings 23 of the adjacent guide elements 2, wherein the spacing of the adjacent mountings 23, and thus of the adjacent guide elements 2 overall, is decreased or increased. This traversing of the mountings 23, and thus of the adjacent guide elements 2 overall, along the layout line 3 is enabled in that the pairing of the splined-shaft profile of the drive spindles 42 with the splined-hub profiles of the screw collars 43 sitting thereon permits axial traversing of the screw collars 43, while relative rotation between the screw collars 43 and the drive spindle 42 is prevented by the pairing of the splined-shaft profiles of the drive spindles 42 with the splined-hub profiles of the screw collars 43 sitting thereon.

In the case of the adjustment installation according to FIGS. 5A, 5B, and 5C, that screw collar 43 that is associated with the first guide element 2 engages, with its external thread, in a threaded bore which is disposed in a locationally fixed manner at the beginning of the assembly of guide elements 2 such that the spacing of the first guide element in relation to this locationally fixed threaded bore varies. In the chosen illustration this first guide element 2 within the assembly is located to the extreme right.

Observing a movement of the adjustment installation 4, in which the drive spindles 42 move the screw collars 43 such that the external threads of the latter are screwed into the internal threads of the bores of the mountings 23 of the respective adjacent guide elements 2, the following will be established:

On account of the first guide element 2 (numerical index k=1) in the manner described being attracted by a path s to the locationally fixed threaded bore, the adjacent second guide element 2 (k=2) being attracted by a path s to the first guide element 2 (k=1), etc., a summary adjustment path which is k times s results for each guide element 2. In an analogous manner, this applies to the reverse movement in which the summary adjustment paths of all guide elements 2 are proportionally increased.

In the case of the adjustment installation according to FIGS. 6A, 6B, and 6C, a locationally fixed zeroth guide element 2 (k=0) which does not vary its position is disposed at the beginning of the assembly of guide elements. In the chosen illustration this zeroth guide element 2 is to the extreme right. The screw collar 43 of said zeroth guide element 2, by way of the external thread of the former, engages in the corresponding threaded bore of the first, that is to say the first movable, guide element 2 which, therefore, during operation of the adjustment installation 4 is moved in relation to the zeroth guide element 2.

Proceeding from the zeroth guide element 2, the guide elements 2 having the numerical indices K=1 . . . 4 are associated with a first group of guide elements 2 which during operation of the adjustment installation 4 are moved in the same direction, that is to say are moved toward the zeroth guide element 2, or away from the zeroth guide element 2. The second group, adjoining thereto, of the guide elements having the numerical indices k=5 . . . 8 are likewise moved in the same direction, but always counter to the guide elements 2 of the first group (k=1 . . . 4). This is achieved in that the screw collars 43 of the second group (=5 . . . 8) are disposed so as to be opposite to the screw collars 43 of the first group (k=1 . . . 4).

Observing a movement of the adjustment installation 4, in which the drive spindles 42 move the screw collars 43 of the first group (k=1 . . . 4) such that the external thread of said screw collars 43 are screwed into the internal threads of the bores of the mountings 23 of respective adjacent guide elements 2, the spacings between the guide elements 2 of the first group (k=1 . . . 4) is decreased. Simultaneously, the external threads of the screw collars 43 of the second group (=5 . . . 8) are screwed out of the associated internal threads of the adjacent guide elements such that the spacings between the guide elements 2 of the second group (=5 . . . 8) is decreased. It applies to each of the two groups of guide elements that the spacing w between each two adjacent guide elements 2 of the observed group of guide elements 2 is uniformly varied along the layout line 3.

It is shown in an exemplary manner in FIGS. 7A, 7B, 7C, and 7D how the adjustment installations according to FIGS. 5A, 5B, and 5C, and 6A, 6B, and 6C are disposed as component parts of folding stations in a folding-box adhesive-bonding machine. Herein, FIGS. 7A and 7B in a perspective view and in a plan view show the folding-box adhesive-bonding machine in a first adjustment for a specific folding-box blank, and FIGS. 7C and 7D in a perspective view and in a plan view show the folding-box adhesive-bonding machine in a second adjustment for another folding-box blank.

To this end, the two folding stations 1 are each disposed on one side of the transportation path 51 of to-be-formed folding-box blanks on the frame 5 of the folding-box machine such that the mutual spacing thereof can be adjusted to adapt to various sizes of folding-box blanks.

Each folding station 1 comprises a base plate 13 having an assembly of lower support rollers 11 on which the folding-box blank, emanating from the right, is transported in a lying manner. A transportation belt 12 is guided over the lower support rollers 11, so as to ensure uniform and slippage-free transportation of the folding-box blanks.

Furthermore, each folding station 1 has a plough-type folding rail 24 which effects forming of a tab of the folding—box blank from the horizontal to the vertical alignment, that is to say about the first 90°. The plough-type folding rail 24 is in each case upstream of the adjustment installation 4 having the guide elements 2. The assembly of rollers 21, adjoining the plough-type folding rail 24, serves for further forming of the tab of the folding-box blank from the vertical to the horizontal alignment, that is to say about the second 90°. Both, the plough-type folding rail 24 as well as the adjoining assembly of rollers 21, serve for guiding a folding belt 25 which is in direct contact with the folding-box blank to be formed, while the latter is moved through the folding station 1 and thereby is folded.

The illustrated folding-box adhesive-bonding machine is set up for carrying out left-before-right folding of two tabs of a folding-box blank, that is to say that the folding procedure for the left tab commences first.

A folding station 1 which has an assembly of two groups of rollers 21, as is illustrated in FIGS. 6A, 6B, and 6C, is disposed on the left side of the transportation path 51. At this folding station 1, that point of the transportation path 51 at which the first portion of forming by way of a fold about 90° is completed, is fixed. This point is defined by the end of the fixedly disposed plough-type folding rail 24. By contrast, however, that point of the transportation path 51 at which folding about 180° is completed is adjustable. This point is defined by the position of the fourth roller 21.

Transportation of the folding-box blank is initially performed along the plough-type folding rail 24)(0 . . . 90°, and then along the assembly of the guide elements 2 in the reversed order of the numerical index thereof, that is to say that the second portion of forming)(90 . . . 180° is performed by the guide elements 2 having k=8 to k=5, and is completed at the guide element 2 having k=4. The guide elements having k=4 to k=0 retain the tab in the horizontal position at 180°.

When viewed in the transportation direction, another two fixed rollers on which the adjustment installation does not act and which define the end of the transportation path 51 are disposed behind the zeroth roller 21.

A folding station 1 which has an assembly of a group of rollers 21, as is illustrated in FIGS. 5A, 5B, and 5C, is disposed on the right side of the transportation path 51. That point of the transportation path 51 at which the first portion of forming by way of a fold about 90° is completed is adjustable on this folding station 1, in that the plough-type folding rail 24 is traversable along the transportation path and is fixable at the desired position. This point is defined by the end of the traversable plough-type folding rail 24.

As is the case on the left side, another two fixed rollers on which the adjustment installation does not act are disposed behind the first roller 21, on the right side when viewed in the transportation direction. The end of the transportation path 51 is defined by the position of these two fixedly disposed rollers 21. That point of the transportation path 51 at which folding about 180° is completed is that position of the first roller 21 that is disposed directly ahead of the two fixed rollers 21.

Transportation of the folding-box blank is initially performed along the plough-type folding rail 24)(0 . . . 90°, and then along the assembly of the guide elements 2 in the reversed order of the numerical index thereof, that is to say that the second portion of forming)(90 . . . 180° is performed by the guide elements 2 having k=5 to k=2, and is completed at the guide element 2 having k=1. The guide element having k=1 retains the tab in the horizontal position at 180°.

### LIST OF REFERENCE SIGNS

1 Folding station
11 Lower support roller
12 Transportation belt
13 Base plate
2 Guide element
21 Roller
22 Roller mount
23 Mounting
24 Plough-type folding rail
25 Folding belt
3 Layout line
4 Adjustment installation
41 Drive installation, motor
42 Drive spindle
43 Screw collar
44 Gearbox
45 Rack
46 Scissor-type mechanism
47 Articulation point
48 Sliding rail
49 Belt drive
5 Frame
51 Transportation path
k Numerical index
s Adjustment path
Δw Spacing variation

1. A folding station for forming flat workpieces, comprising at least one group of k guide elements which along a layout line are attached having a variable mutual spacing w, wherein the guide elements are operatively connected to a common and proportionally acting adjustment installation which during operation uniformly varies the spacing w between each two mutually adjacent guide elements of the group of guide elements along the layout line.

2. The folding station according to claim 1, wherein the adjustment installation has at least one drive spindle and screw collars which interact with the at least one drive spindle and the guide elements.

3. The folding station according to claim 2, wherein the screw collars are disposed so as to be rotatably fastened to the guide elements and to be rotationally secured and traversable on the drive spindle.

4. The folding station according to claim 2, wherein the at least one drive spindle comprises a first drive spindles and a second drive spindle disposed so as to be mutually parallel, wherein the first drive spindle is operatively connected to all guide elements having an odd numerical index k, and the second drive spindle is operatively connected to all guide elements having an even numerical index k.

5. The folding station according to claim 1, wherein each two mutually adjacent guide elements are operatively interconnected by in each case one screw collar.

6. The folding station according to claim 1, wherein a zeroth guide element (k=0) is fixedly disposed, and all other guide elements (k>0) during operation of the adjustment installation are moved towards the zeroth guide element or away from the zeroth guide element.

7. The folding station according to claim 1, wherein the at least one group of k guide elements comprises at least two groups of guide elements disposed along the same layout line and operationally connected to the same proportionally acting adjustment installation.

8. The folding station according to claim 7, wherein during operation of the adjustment installation the spacing of each two mutually adjacent guide elements of the first group is enlarged, and at the same time the spacing of each two mutually adjacent guide elements of another group is reduced.

9. A folding-box adhesive-bonding machine having a transportation installation for folding-box blanks, and at least one folding station according to claim 1.
